(19) United States
(12) Patent Application Publication
(10) Pub. No.: US 2014/0005996 A1
(43) Pub. Date: Jan. 2, 2014

(54) INTERACTIVE AND THREE-DIMENSIONAL WELL PATH DESIGN

(71) Applicant: Schlumberger Technology Corporation, Sugar Land, TX (US)

(72) Inventors: Vivek Jain, Beijing (CN); Qing Liu, Beijing (CN); Peng Xie, Beijing (CN); David Wales, Beijing (CN); Thomas Gehrmann, Hundvaag (NO); Mi Zhou, Denver, CO (US); Odd B. Hagenes, Lund (SE)

(21) Appl. No.: 13/929,299

(22) Filed: Jun. 27, 2013

Related U.S. Application Data
(60) Provisional application No. 61/665,647, filed on Jun. 28, 2012.

(51) Int. Cl. G06T 17/00

(52) U.S. Cl. CPC G06T 17/00
USPC 703/10

(57) ABSTRACT

Methods, systems, and media for well planning are provided. The method includes displaying a three-dimensional representation of a subterranean domain, and receiving a selection of a location in the representation of the subterranean domain. The method also includes identifying an object of a well plan associated with the location, and receiving an instruction to modify the object. The method further includes editing data associated with the object based on the instruction, and visibly modifying the object in the representation of the subterranean domain, substantially in real-time with respect to receiving the instruction. The method also includes determining, using a processor, that the editing of the data results in at least a portion of the well plan being outside of a constraint, and changing a display of the object to indicate that the editing results in the at least a portion of the well plan being outside of the constraint.

### CROSS-REFERENCE TO RELATED APPLICATION

This application claims priority to U.S. Provisional Patent Application Ser. No. 61/665.647, filed on Jun. 28, 2012, the entirety of which is incorporated herein by reference.

### BACKGROUND

“Well planning” is the process of mapping the shape and trajectory of a path for a wellbore prior to or during drilling, so as to reach or intersect one or more targets in an efficient manner while maximizing the likelihood of success. Drilling hardware and techniques allow for steering of the drill string to match the desired path, subject to limiting physical factors. Thus, the drilling operators are able to follow the well plan, which may range in shape from simple (e.g., a vertical well) to complex.

To plan a suitable path, a variety of modeling interfaces and engines are available. Typically, a target (e.g., a reservoir) is identified and one or more well paths are plotted and extend through discretized points that are positioned between the surface and the target. The modeling engines may begin with one or more templates or “bases” for the well plan, which provide a geometric shape representing the path the wellbore takes, e.g., to reach the target. A single well plan may include one basis or several bases, which form the overall profile of the well plan.

A variety of factors may influence well planning and in some cases, may call for deviations from the standardized bases, or otherwise editing or building a well plan. However, customizing the bases, well plan sections, etc. can be time-consuming, and may require specialized knowledge of the bases, which may make the well-planning process cumbersome.

### SUMMARY

Embodiments of the disclosure may provide systems, methods, and media for planning a well path by interaction with and real-time updating of a three-dimensional view of a subterranean domain. For example, the system may include functionality to edit a point or section of a well plan (i.e., the plan for the well path) and/or edit, replace, add, or delete a section thereof. Depending, for example, on the mode selected, attributes for editing may be displayed and/or constrained. The user may select from the attributes for editing and provide instructions, such as by dragging one or more attribute indicators for the editing desired. The system may respond to such instructions substantially in real-time by updating views of the representation of the domain. Further, the system may impose constraints and visually indicate when constraints are broken. Moreover, the system may provide template bases for section replacement and/or insertion and may provide for automatic deletion and stitching of sections of the well plan.

These and other aspects of the disclosure will be described in greater detail below. Accordingly, it will be appreciated that the foregoing summary is intended merely to introduce a subset of the aspects described below and is, therefore, not to be considered limiting on the present disclosure.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a flowchart of a method for planning a well path, according to an embodiment.

FIG. 2 illustrates a perspective view of a three-dimensional representation of a subterranean domain, including a well plan therein, according to an embodiment.

FIG. 3 illustrates a flowchart of a point editing process, according to an embodiment.

FIG. 4 illustrates a view of a point including attributes for editing, according to an embodiment.

FIG. 5 illustrates a view of a point indicating inclination as the attribute for editing, according to an embodiment.

FIG. 6 illustrates a view of a point indicating azimuth as the attribute for editing, according to an embodiment.

FIG. 7 illustrates a view of a point indicating position in a horizontal plane as the attribute for editing, according to an embodiment.

FIG. 8 illustrates a view of a point indicating position in a vertical plane as the attribute for editing, according to an embodiment.

FIG. 9 illustrates a flowchart of a section editing process, according to an embodiment.

FIG. 10 illustrates a flowchart of a section adding process, according to an embodiment.

FIG. 11 illustrates a flowchart of a section deletion process, according to an embodiment.

FIG. 12 illustrates a simplified schematic view of a processor system, according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

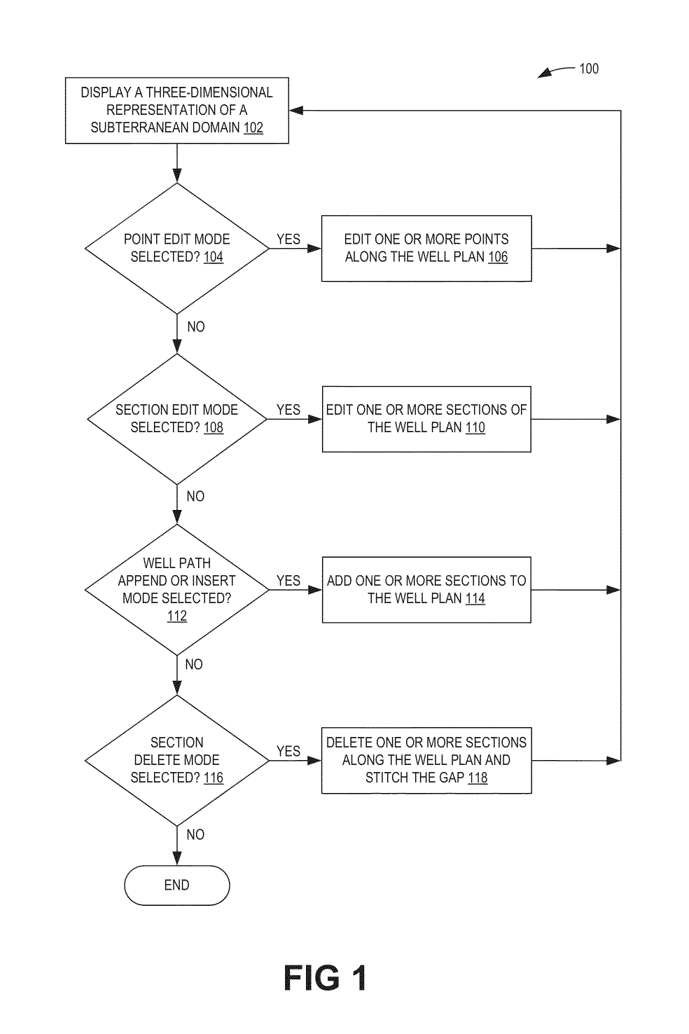

FIG. 1 illustrates a flowchart of a method 100 for well planning, for example, substantially in real-time and using a dynamic, three-dimensional representation of a subterranean formation, according to an embodiment. Accordingly, the method 100 may begin by displaying the three-dimensional representation of a subterranean domain, as at 102. The representation of the subterranean domain may be constructed using data collected from any suitable formation-mapping process, such as, for example, one or more seismic profiles. Such mapping may provide data indicative of a stratigraphy of the domain, a location of one or more reservoirs, other geologic data, and/or the like.

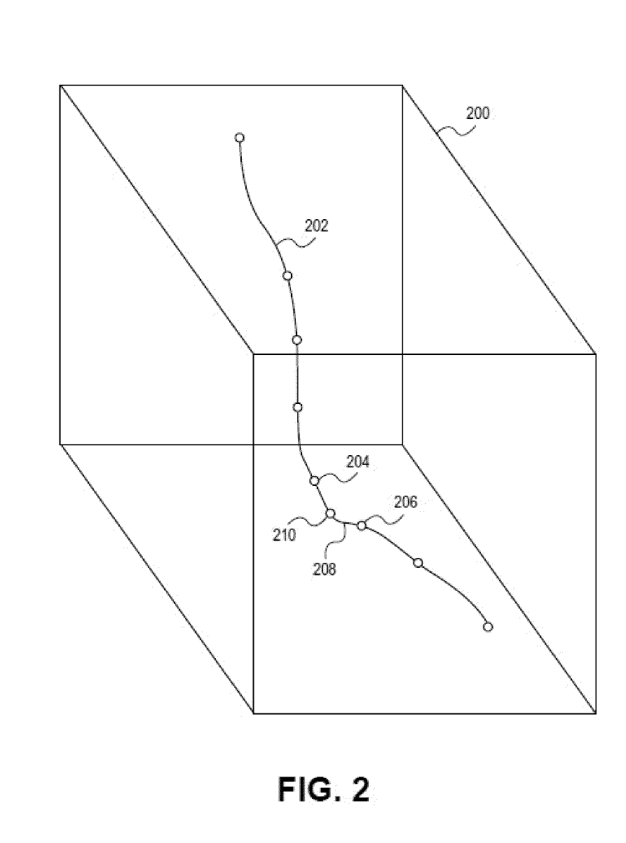

FIG. 2 illustrates an example of such a representation of a subterranean domain, generally indicated by reference numeral 200. For purposes of this disclosure, stratigraphic layers and other geologic features, which may or may not be part of the representation of the domain 200, are omitted from view. In some instances, the representation of the subterranean domain 200 may include a well plan 202, which may be representative of a path along which a well may be, has been, or is being drilled. The well plan 202 may include a plurality of points, which may be discretized locations along the generally continuous well plan 202. Sections of the well plan 202 may be defined between design points of the plurality of points; for example, as shown, section 208 may extend between design points 204, 206.

The plurality of points may also include control points 210 defined at locations along the well plan 202 between two such design points 204, 206. For example, the control points 210 may define a location of a point of inflection along the section 208; that is, where the section 208 changes direction. A single section 208 may include any number of control points 210, for example, depending on the complexity of the shape of the section 208.

The geometric shape of the section 208 may be referred to as a “basis” of the section 208. As will be described in greater detail below, the basis of the section 208 may begin with a template, including one or more predetermined attributes, rules, constraints, and/or the like (e.g., shape, location, etc.). The template may be selected by a user, or by a processor according to a variety of determining factors, to extend between two design points, e.g., the design points 204, 206. However, the shape of the section 208 may be modified by a user, for example, by the user changing one or more attributes of one or more design and/or control points 204, 206, 210, as will be described in greater detail below. Further, the set of bases (whether customized or standard) of the sections 208, which link together to form the well plan 202, may be referred to as the “profile” or “drilling profile” of the well plan 202.

Referring now to both FIGS. 1 and 2, the method 100 may include choosing one of several modes of editing. This choice may result in one or more of several processes being performed, for example, using the input of a user and/or automatically. In at least one embodiment, the choice is dictated by input from a user, e.g., selecting one of the modes using one or more input peripheral devices such as a mouse, keyboard, touchscreen, position sensors, optical inputs, microphones, etc.

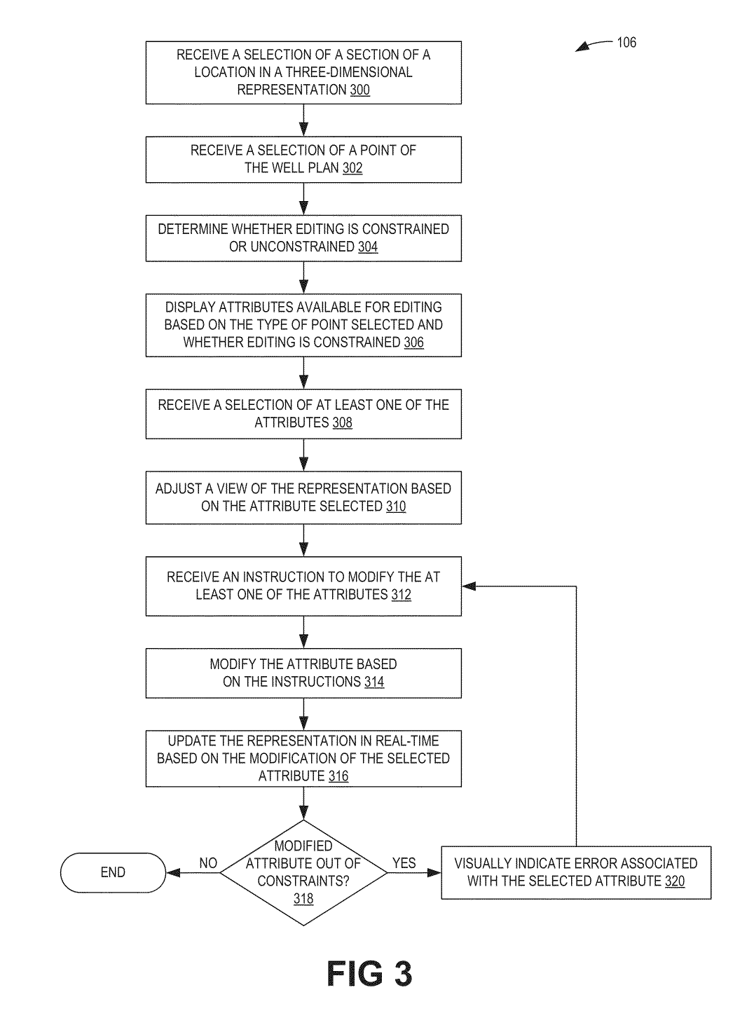

For example, the method 100 may include determining whether a point editing mode is selected, as at 104. If a point editing mode is selected, the method 100 may proceed to editing one or more points (e.g., points 204, 206, 210) of the well plan 202, as at 106. With continuing reference to FIG. 2, FIG. 3 illustrates a flowchart of editing one or more points 204, 206, 210 of the well plan 202, as at 106, which may also be referred to herein as “the point editing process 106,” according to an embodiment.

The point editing process 106 may begin by receiving a selection of a section 208 of the well plan 202 in the three-dimensional representation of the domain 200, as at 300. The section 208, once selected, may be highlighted, enlarged, change color, or otherwise be visually and/or audibly indicated as being selected in the three-dimensional representation of the domain 200. In some embodiments, the point editing process 106 may also include responding to the selection of the section 208 by zooming-in, changing viewing angles, and/or otherwise modifying the display of the three-dimensional representation of the domain 200, so as to enlarge or otherwise increase visible details of the selected section 208.

The point editing process 106 may also include receiving a selection of at least one of the points 204, 206, 210 of the selected section 208, as at 302. This may more generally be referred to as selecting an “object” for editing, as part of the method 100; thus, in the context of the point editing process 106, the object selected may be one or more of the points 204, 206, 210. The selected one of the points 204, 206, 210 may be highlighted, e.g., enlarged and/or depicted in a different color, so as to visually differentiate the selected one of the points 204, 206, 210 from adjacent points and/or other features of the representation of the domain 200. The points 204, 206, 210 may be selectable by direct interaction with the representation of the domain 200 (e.g., using a cursor controlled by a mouse or another input peripheral), using a drop-down menu or a list of the defined points of the selected section 208, or in any other manner. Once a point is selected, the representation of the domain 200 may be altered, so as to enlarge, rotate, or otherwise provide a more detailed view of the selected point. In some embodiments, the selected one of the points 204, 206, 210 may be selectable without first selecting the section 208.

Before, during, or after receiving the selections as at 300 and 302, the point editing process 106 may include determining whether editing is constrained or unconstrained, as at 304. “Unconstrained” editing may provide for a maximum range of attribute editing by, for example, automatically changing the section 208 to one that allows for a maximum range of attribute editing. Since the control point 210 is contained in the section 208, which connects to the two design points 204, 206, the range of editing available for the control point 210 may be naturally limited. For example, despite the editing being unconstrained by external rules, the section 208 may still proceed from the control point 210 to the design point 206. Editing of the design points 204, 206 may, however, not be subject to such natural limitations, as the design points 204, 206 are found at the ends of the section 208 lines, and thus may have a greater degree of freedom.

Constrained editing may impose certain limits on the editing of the design points 204, 206, the control point 210, or both, for example, within a certain basis of the selection 208. For example, such limits may be imposed consistent with the basis of section 208 as well as operating parameters of known drilling equipment, business objectives (e.g., minimizing costs associated with well plan turns), physical limitations, risk tolerance, intersection avoidance with other well paths (or well plans) or with a proximal to the surface point of the well plan 202. Further, these factors and/or others may be used alone or in any combination, according to, e.g., user selections or predefined rules. In some cases, constrained editing may limit the range, number, and/or type of attributes of the selected one of the points 204, 206, 210 that may be edited based on the constraints. Furthermore, certain constraints may be imposed as a result of attribute combinations. For example, dog leg severity (DLS) may result from position or trajectory changes of a point, and limits on DLS may operate to impose limitations on modifications to either or both position and trajectory.

The point editing process 106 may also include displaying attributes available for editing, as at 306. Determining the attributes available for editing may be based on, for example, the type of point selected at 302. As noted above, the design points 204, 206 may have a greater degree of freedom than control point 210; accordingly, one or more attributes may not be available for editing in a control point 210 that may be available for the design points 204, 206. Further, whether constrained or unconstrained editing is active at 304 may impact the number and/or type of attributes available for editing. The attributes not available for editing may be omitted from view, displayed but distinguished (e.g., “greyed-out,” dashed, blinking, etc.) from attributes that are available for editing, or may be displayed with no difference from the attributes that are available for editing.

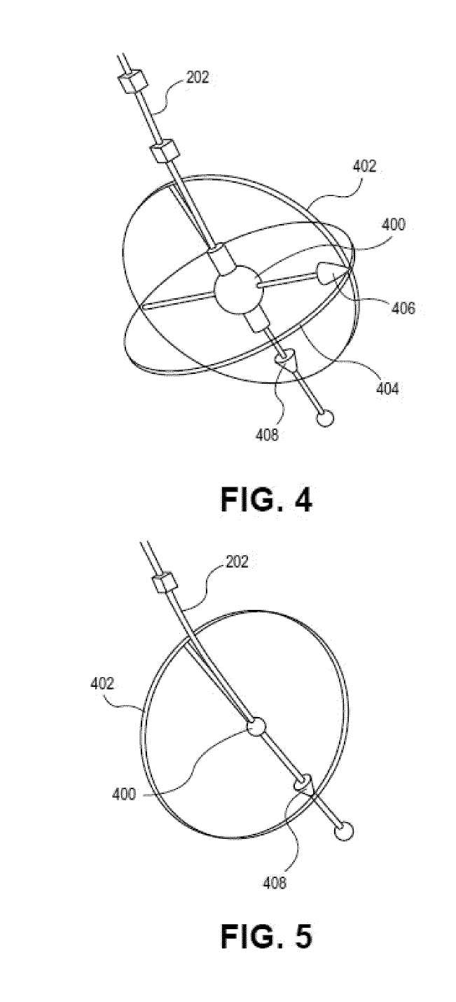

FIG. 4 illustrates an interactive display of a point 400 of the well plan 202, showing attributes available for editing, according to an embodiment. As shown, by selection of the point 400, the point 400 may be enlarged relative to the well plan 202 and/or other points thereof and may be centered in the view. The view of FIG. 4 may, for example, be a separate window, showing the point 400 and an enlarged portion of the domain 200, alongside the full representation of the domain 200. The two views (e.g., of FIGS. 2 and 4) may be linked and updated in tandem, substantially simultaneously, in response to editing. Accordingly, alterations to the attributes displayed in the view illustrated by FIG. 4 may be reflected in changes in the representation of the domain 200 including the full (or a greater portion of) the well plan 202. In other embodiments, the view of FIG. 4 may be provided by a pop-up window, call-out box, or a temporary viewer, which may be displayed until point editing and/or editing of one attribute is completed or by modification of the view of FIG. 2.

As the term is used herein, “substantially simultaneously” is generally defined to mean that two events occur at least nearly at the same time, with the difference in time, in some cases, being intended to be generally imperceptible to a human. For example, two instructions executed by a single processor may occur consecutively; however, given sufficient processing speed, the results of the two instructions may be provided within seconds or a fraction of a second of one another. Additionally, two instructions executed by two processors (e.g., in parallel) may occur even closer to precisely simultaneously. Both cases are considered to be within the use of the term “substantially simultaneously.”

As shown, the attributes for editing may include the trajectory of the well plan 202 at the point 400, for example, the azimuth 406 and inclination 408. The azimuth 406 and inclination 408 may be illustrated by arrows (as shown) or other suitable indicators. Further, the azimuth 406 and the inclination 408 may be defined in a range, illustrated by the circular planes 404, 402, respectively. The attributes for editing may also include location, for example, along a horizontal plane (X and Y directions) and a vertical plane or depth (Z direction), or along or in relation to a geological surface (including surface, horizons, faults, etc.). These positional attributes may be represented by the point 400 itself, which may, for example, be selected and moved to a new location, as will be described in greater detail below. In other embodiments, arrows or other indicators may be provided to visually depict the positional attributes for movement. Additionally, the view of FIG. 4 may also include a depiction of true north, which may provide a reference for the azimuth 406.

Referring again to FIG. 2, the point editing process 106 may then proceed to receiving a selection of at least one of the attributes, as at 308. The selection at 308 may proceed by a user clicking or otherwise indicating one of the attributes in the window shown in FIG. 4. For example, the user may select the arrow representing the azimuth 406 or the inclination 408 so as to modify a trajectory of the well plan 202 at the point 400. Additionally, the user may select the point 400 itself, so as to change its position in the domain 200. In other embodiments, the attribute may be selected as a row or column in a spreadsheet or menu that may be available at least after the point 400 is selected.

Once an attribute is selected at 308, the point editing process 106 may again adjust the view of the selected point 400, as at 310. For example, if azimuth 406 or inclination 408 (or both) is selected, the view may rotate to show a range of trajectories. Similarly, if position is selected as the attribute to be modified, the view may be changed (e.g., zoomed out and/or rotated) to show a range of positions, e.g., along the horizontal, vertical, or another plane or surface, depending on user selections, defaults, heuristics, etc.

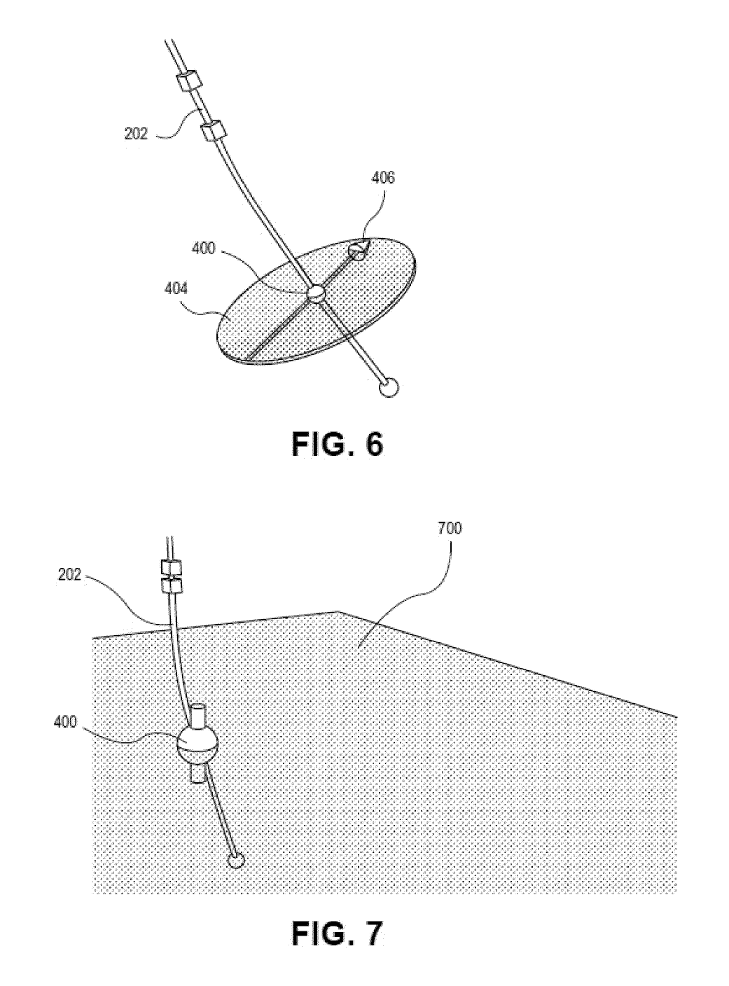

FIGS. 5 and 6 show two such adjustments to the view of FIG. 4, according to whether inclination 408 or azimuth 406 is selected for editing, respectively. Compared to FIG. 4, the view of FIG. 5 may be closer to a side, elevation view (although it may remain in perspective so as to indicate depth), so as to show changes to the well plan 202 trajectory as the inclination 408 is modified. The view may also omit the azimuth 406 and its range (as indicated by the circular plane 402), so as to isolate the depiction to the attribute(s) selected for editing.

As shown in FIG. 6, the view may be modified to be an appropriate raised perspective (although other perspective angles may be employed), so as to, for example, show a full range of azimuth 406 directions. The view of FIG. 6 may also omit the inclination 408 and the range of inclination angles indicated by the circular plane 402, so as to focus the view on the attribute selected for editing.

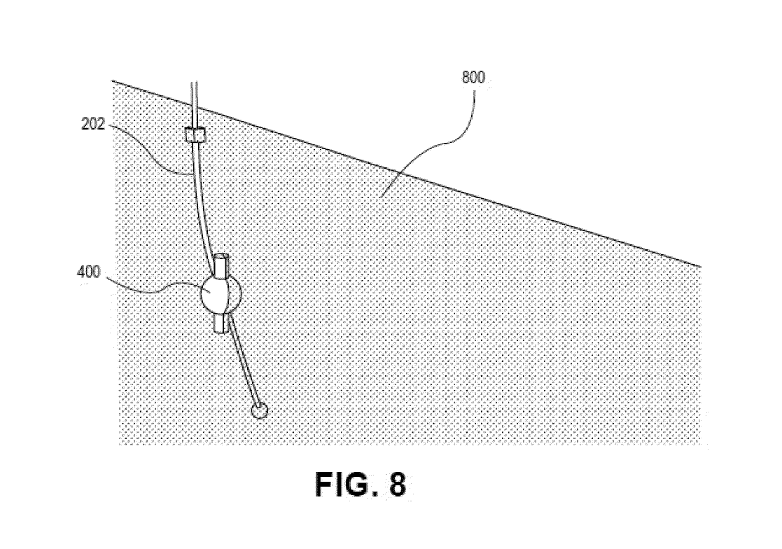

Similarly, FIGS. 7 and 8 illustrate views of the point 400 adjusted for modifying the position of the point 400 in a horizontal plane 700 and in a vertical plane 800, respectively. The planes 700, 800 may limit the change in the position of the point 400 to being along the plane 700, 800 associated with the attribute being edited. Although horizontal and vertical planes 700, 800 are illustrated, it will be appreciated that the planes 700, 800 may extend at any angle, e.g., as selected by a user, or conform to or be related to another surface or object, according to rules adapted to the editing situation environment, and/or other factors.

In some embodiments, the point editing process 106 may include a tracing function. The tracing function may illustrate the departure of the trajectory and/or position of the point 400 caused by the editing. The tracing function may be shown individually for each attribute edited, e.g., in the appropriate view of FIGS. 5-8, and/or may be shown in the aggregate in a view such as that of FIG. 4. For example, a phantom image (e.g., grayed or in dashed lines) may indicate a displacement caused by the editing and/or may show a previous position of the point 400 and/or a trajectory of the well plan 202 at the point 400. Furthermore, such tracing may also include a phantom image of the well plan 202 prior to editing.

In some embodiments, more than one attribute may be selected for editing at a single time. For example, in FIG. 4, both inclination 408 and azimuth 406 may be selected together. Further, the position of the point 400 may be edited in two or three dimensions simultaneously, thereby allowing modification of the x, y, and/or z position of the point 400.

The views of FIGS. 5-8 may, like the view of FIG. 4, be displayed in windows, alongside the representation of the domain 200 shown in FIG. 2 and/or may be modifications to the view of FIG. 4. Updates to the selected attributes may be reflected substantially simultaneously in each of the views shown. When the attribute shown in the appropriate one of FIGS. 5-8 is no longer selected for editing, the window (or other type of display) illustrating the editing of this attribute may close. In some embodiments, the view of FIG. 4 may be closed and/or obscured while editing of one of the attributes is conducted. In other embodiments, the views of editing each of the attributes, as shown in FIGS. 5-8, and/or others, may be shown at once. Accordingly, selection of the available attribute for editing may proceed by activating the window containing the indicator (e.g., arrow) for this attribute.

The point editing process 106 may then proceed to receiving an instruction to modify the attribute(s) selected, as at 312. In some cases, such an instruction may take the form of dragging a cursor, moving a pointer object, etc., once the attribute has been selected at 310, so as to visually indicate the desired modification. In this case, the arrows representing the azimuth 406 and inclination 408 may be referred to as “draggers.” In other cases, the instruction may be in the form of incremental increases or decreases to a number (e.g., angle, position in an axis, etc.), such as by pressing an up or down arrow (e.g., on a display or keyboard). It will be appreciated that various other forms of inputs may be employed without departing from the scope of the present disclosure.

The point editing process 106 may include modifying the attribute(s) based on the instructions received, as at 314. The attribute may be stored as or otherwise represented by a number (e.g., an angle), and thus the modification of the attribute, however entered, may, in some embodiments, result in the updating of the number associated therewith, and updating any other associated information, such as curve-fits, geometries, etc. allowing the section 208 to reach the next point, e.g., in the case of editing attribute(s) of a control point 210.

In response to updating the number, the point editing process 106 may update the representation of the domain 200, as at 316. The updating at 316 may be substantially in real-time with respect to receiving the instructions at 312. As the terms are used herein with respect to updating views, “in substantially real-time” and “substantially in real-time” are equivalent and generally defined to mean that the editing of the view appears to occur substantially simultaneously to entering the instructions received at 312.

For example, in FIG. 5, the instruction at 312 may include a user dragging the arrow indicating the incline 408 to modify the dip attribute of the section 208 at the selected point 400. As such, the instruction may be received over a period of time. The point editing process 106 may consider the dragging during the period of time incrementally, converting the dragging to a plurality of sequential instructions. The point editing process 106 may implement each of the instructions sequentially, for example, implementing one while the next sequential instruction is being entered by the user continuing to drag the arrow representing the incline 408 502. As noted above, the implementation may proceed by modifying the attribute at 314 and displaying the modified representation of the domain 200. As this may occur while the user continues to drag arrow representing the incline 408 at least partially during the period of time, and at an update rate sufficient to appear generally seamless to the user, the representation of the domain 200 may appear to be modified substantially in real-time. Similarly, any of the other views (e.g., any of those shown in FIGS. 5-8) may also appear to be edited substantially in real-time with respect to the reception of the instructions at 312 and/or the modification of the representation of the domain 200, regardless of the attribute being modified.

The point editing process 106 may also check to determine whether the editing instructions received, e.g., modifying the attribute(s), result in well path 202 being outside of constraints, as at 318. If the modification to the attribute is determined to place the well path 202 out of applicable constraints, an error or warning may be displayed to a user, as at 320. For example, at least in unconstrained editing the attribute indicator of the point 400, e.g., the arrow indicating incline 408 or the azimuth 406 may change color to visually indicate that the attribute renders a part of the well plan 202 outside of constraints. Additionally, in unconstrained editing, the point editing process 106 may consider if other available bases for the section 108 would allow the desired attribute modification, and, if such a basis is available, switch the basis of the section 208 for the other basis. In other cases, the ranges for the attributes indicated by the circular planes 402, 404 may include an indication of in-constraint regions and/or out-of-constraint regions, such as by using color-coded wedges.

In constrained editing, the user may additionally or instead be prevented from modifying the attribute to reach such an out-of-constraints region. In such case, the point editing process 106 may determine that the instruction received at 312 results in the desired modification rendering the attribute out of constraints. The point editing process 106 may abstain from modifying at 314 and/or updating at 316 and may ignore the instruction, or indicate an error, such as an audible tone and/or audible or visual error message, notifying the user that the instructed modification is being prevented. If such an error occurs or an instruction is prevented, the point editing process 106 may prompt for alternative instructions from the user and/or display an error message. The determination of such out-of-constraints modification may occur prior to or after displaying the desired modification. If determined prior to displaying, the point editing process 106 may omit such a display and instead indicate an error.

The point editing process 106 and/or portions thereof may repeat as necessary to handle instructions received for a single attribute, a sequential selection and modification of multiple attributes, and/or a sequential selection and modification of one or more attributes of multiple points. Prior to completion, the point editing process 106 may include one or more post-processing techniques, for example, to indicate any remaining warnings or errors indicative of attributes being out of constraints, generating reports, calculating risk changes, etc.

Returning to FIG. 1, the method 100 may allow for another mode to be selected. For example, the method 100 may include determining that a section editing mode is selected, as at 108. If it is, the method 100 may proceed to editing one or more sections 208 (FIG. 2) of the well plan 202, as at 110.

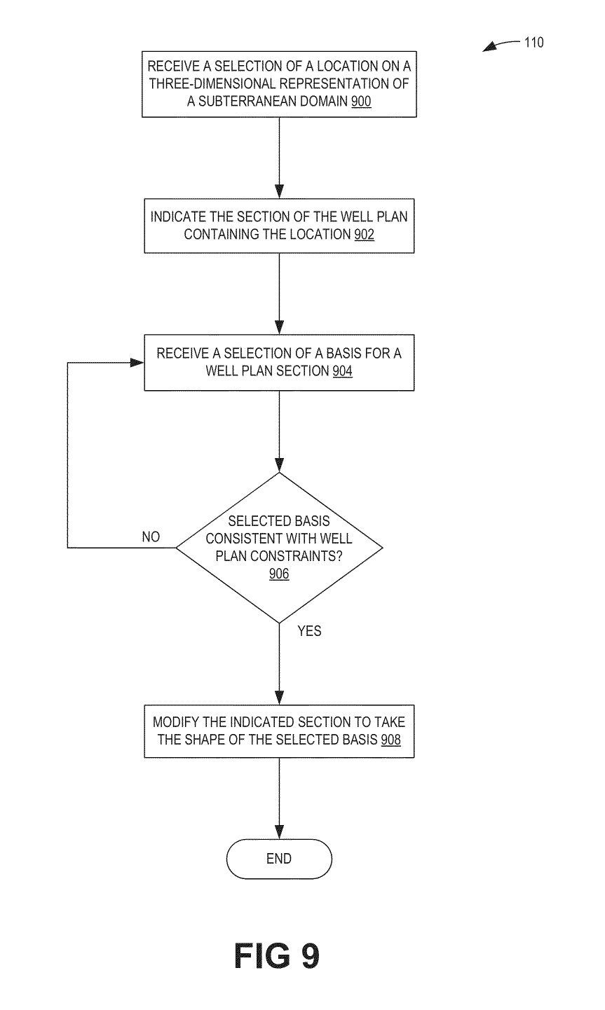

FIG. 9 illustrates a flowchart of editing the one or more sections 208 (“the section editing process 110”), according to an embodiment. The section editing process 110 may proceed by receiving a selection of a location of the three-dimensional representation of the domain 200, as at 900. The location may be associated with a particular section 208 of the well plan 202. Receiving the selection and determining the section 208 intended to be selected may more generally be referred to as selecting an object for editing, as part of the method 100; thus, in the context of the section editing process 110, the object selected may be the section 208. For example, the location may be part of the section 208, nearest to the section 208, or the like. Once the section 208 is determined, it may be indicated in the three-dimensional representation of the domain 200, as at 902, for example, by changing the color, highlighting, causing the section 108 to blink, etc.

Before, during, or after such selection, the section editing process 110 may provide a library or other type of selection of basis templates. The library may display several different types of standard or customized basis templates. For example, the library may display L-shaped, J-shaped, S-shaped, I-shaped, or other bases.

The section editing process 110 may then proceed to receiving a selection of one of the basis templates, as at 904 and may determine whether it is suitable to replace the selected section 208, as at 906. These two aspects at 904 and 906 may occur in either order. For example, upon receiving a selection of the section 208 to be edited, the library may dynamically remove from consideration any bases that are unsuitable for use with the section 208, based on any factor, such as DLS, geological considerations, etc. Thus, the remaining displayed bases may all be determined to be consistent with well plan constraints prior to being selected.

In another embodiment, the library may be static, and characteristics of the section 208 selected at 904 might not alter the library of displayed bases. Accordingly, upon selection of the section 208 and selection of the basis to replace the section 208, the point editing process 106 may proceed to determining whether the selected basis is consistent with the well plan constraints at 906. If the selected basis is determined to be inconsistent with the well plan constraints, the section editing process 110 may display an error and return to allowing the user to select a basis.

This static library embodiment may avoid consideration of whether multiple bases would be within constraints when a single basis may be employed to replace the selected section 208. The dynamic library embodiment, on the other hand, may avoid or reduce trial-and-error iterations performed by a user and thus promote rapid section editing. Further, some embodiments may combine dynamic and static libraries, for example, allowing a user to select a subset of the available basis and determining which of the detected subset is suitable. Moreover, in some cases, the section editing process 110 may include highlighting or otherwise suggesting one or more of the bases as being more suitable than others, despite both being within constraints. A variety of such implementations may be employed by one of skill in the art with the aid of the present disclosure.

When the basis is selected at 904 and determined to be within constraints at 906, the section editing process 110 may proceed to implementing the selections and modifying the selected section 208 with the selected basis, as at 908, such that the modified section 208 takes the shape of the basis. In some embodiments, this may end the section editing process 110. In other embodiments, various post-processing techniques may be employed prior to terminating the section editing process 110. For example, an analysis of the change in risk associated with the section 208 replacement, constraints that may be violated, etc., may be calculated and displayed.

In another embodiment, if the selected basis is determined to be inconsistent with the well plan constraints at 906, the section editing process 110 may proceed to modifying the section 208 at 908, but may visually, audibly, etc., indicate that the modified section 208 is outside of constraints. This may prompt the user to edit one or more points of the modified section 208, e.g., as at 106 (FIG. 1).

Returning to FIG. 1, the method 100 may proceed back to displaying the three-dimensional representation of the domain 200. Accordingly, the method 100 may proceed back to the point editing process 106, for example, to alter one or more points of the section 208 modified in the section editing process 110. Additionally, the method 100 may include determining whether an insertion or well plan appending mode is selected, as at 112. In some cases, such a mode may be employed to extend a pre-existing well plan 202. In others, this mode may be employed to build a new well plan 202, starting, for example, at a target point (e.g., a reservoir location), a surface point, or any one or more points therebetween. If the well plan append or insert mode is selected at 112, the method 100 may proceed to adding one or more sections 208 to the well plan 202, as at 114.

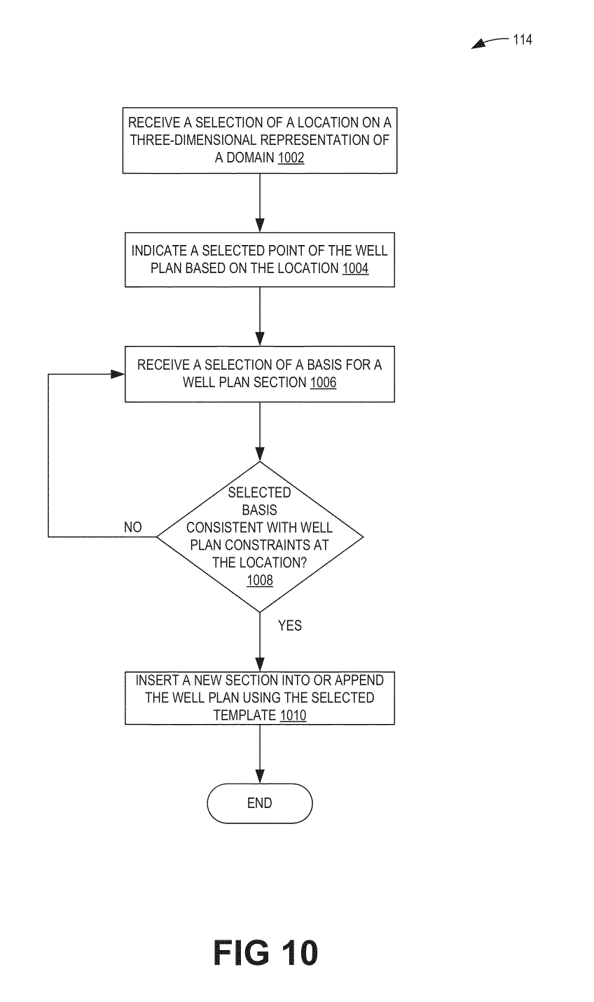

FIG. 10 illustrates a flowchart of adding one or more sections 208 to the well plan 202 at 114 (“the section adding process 114”), according to an embodiment. The section adding process 114 may begin at 1002 by receiving a selection of a location on the three-dimensional representation of the domain 200, as shown in FIG. 2. The location may be indicative of, e.g., a design point of a terminal section of the well plan 202, to which a new section is to be appended, or of a design point acting as a starting point for building a new well plan 202. The location may also indicate a design point bordering a region between two sections of a well plan 202, where an inserted section 208 may be placed. Once the point indicated by the selection of the location at 1002 is resolved, the point may be highlighted, enlarged, or otherwise indicated in the three-dimensional representation of the domain 200, as at 1004. Receiving the selection and determining the design point intended to be selected may also more generally be referred to as selecting an object for editing, as part of the method 100; thus, in the context of the section adding process 114, the object selected may be the design point.

The selection of the location at 1002 may also include selecting a second location, e.g., a location to which the new section 208 will extend, such as a point on another section or another point in the domain 200. In other embodiments, the length of the new section may be selectable, predetermined, or determined according to one or more rules associated with the environment of the well plan 202.

The section adding process 114 may also include displaying bases that may be selected to append or insert into the well plan 202. Like the section editing process 110, the section adding process 114 may display a library or menu of bases, whether standard, customized, or both, that may be selected by a user to append or insert into the well plan 202. Further, the section adding process 114 may include receiving a selection of one of the bases (e.g., by selecting the basis from the displayed library) for use, as at 1006. The section adding process 114 may then determine whether the selected basis is consistent with well plan constraints, as at 1008.

Also like the section editing process 110, the section adding process 114 may receive the selection at 1006 and determine whether the selected basis is consistent with well plan constraints at 1008 in either order. For example, the section adding process 114 may employ a dynamic library, which may alter or otherwise indicate the profiles suitable for use extending from the selected design point 204 or 206, thereby determining consistent at 1008 prior to receiving the selection of the bases at 1006. In other embodiments, the section adding process 114 may determine consistency with constraints at 1008 after receiving the selection at 1006.

If the selected basis is inconsistent with the constraints, an error may be displayed and a prompt issued for a different basis to be selected. Otherwise, the basis may be extended from the selected design point in any direction, for example, as indicated by a user toward the second location, thereby appending the well plan 202, as at 1010.

In another embodiment, if the selected basis is determined to be inconsistent with the well plan constraints at 1008, the section adding process 114 may proceed to inserting the section into or appending the well plan at 1010, but may visually, audibly, etc., indicate that the new section 208 is outside of constraints. This may prompt the user, for example, to edit the new section 208, as at 110 (FIG. 1) and/or one or more points thereof as at 106.

Once the basis is appended or inserted into the well plan 202 as a new section 208, the section adding process 114 may include one or more post-processing techniques, such as, for example, calculating and displaying metrics, risk changes, compliance with constraints, costs, etc. In other embodiments, post-processing may be omitted.

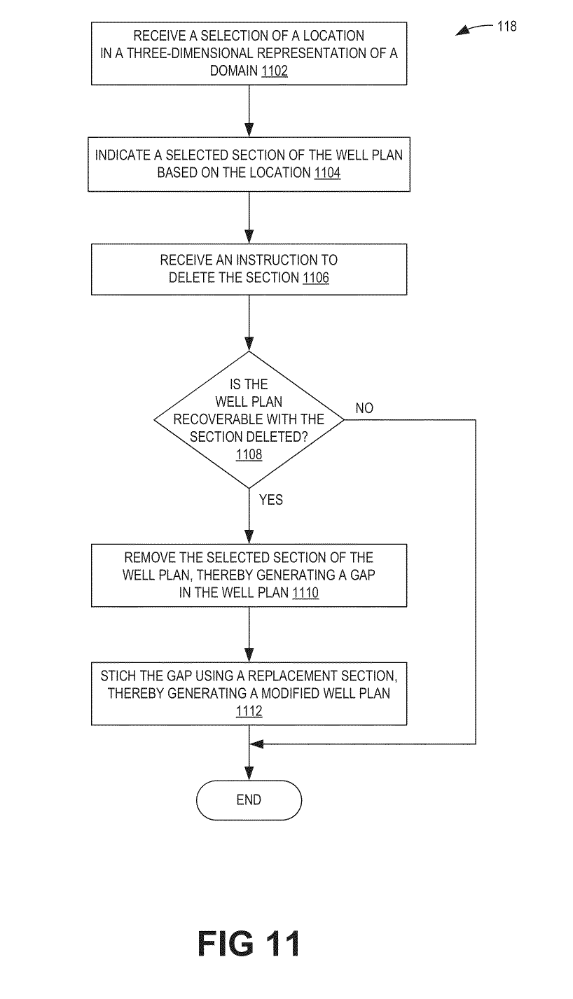

Returning to FIG. 1, the method 100 may also determine whether a section delete mode is selected, as at 116. If it is, the method 100 may proceed to deleting one or more sections along the well plan 202 and “stitching” the gap created by the section 208 removal, as at 118. FIG. 11 illustrates a flowchart of deleting and stitching at 118 (“the section deletion process 118”), according to an embodiment.

The section deletion process 118 may begin by receiving a selection of a location in the three-dimensional representation of the domain 200, as at 1102. The selection of the location may be employed to determine a section 208 that is intended to be selected. Receiving the selection and determining the section 208 intended to be selected may be generally referred to as selecting an object for editing, as part of the method 100; thus, in the context of the section deleting process 118, the object selected may be the section 208.

Once the selected section 208 is determined, the section deletion process 118 may include indicating the selected section 208, as at 1104. The section deletion process 118 may then receive an instruction to delete the section 208, as at 1106. In some cases, this instruction may be a response to a prompt, confirming that the indicated section 208 is the correct section to be deleted, and/or a delete keystroke, etc.

Deleting a section 208 between two design points 204, 206 may leave a gap in the well plan 202 between the design points 204, 206. The well plan 202, however, is generally continuous, so as to be followed by drilling equipment from a drilling location. Accordingly, the section deletion process 118 may include determining whether the gap can be automatically stitched, i.e., whether the continuity of the well plan 202 can be recovered with the selected section 208 removed. Such recovery may proceed by replacing the deleted section 208 with another section 208 having a basis that is determined to fit, is predetermined, or is selected as a default basis. Recovery may also proceed by extending one or more adjacent sections 208 previously terminating at, for example, the design point 204 toward the other design point 206, effectively deleting the design points 204 or converting it to a control point. Additionally, the section deletion process 118 may include extending both adjacent sections 208 toward one another, thereby creating a new design point where the two sections 208 meet, and deleting the design points 204, 206 or converting them to control points. Alternatively, the section(s) 208 distal (away from the surface) to the selected section 208 may be moved together so as to remove the gap by shortening the well plan 202.

Such automatic solutions may, however, result in the altered section(s) becoming outside of constraints. In some cases, this may be indicated to the user in the form of an error message, with an audible tone, or by altering a visible characteristic (e.g., color) of the section 208, or by leaving the gap, to be deleted. In such case, the well plan 202 may be considered to not be automatically recoverable at 1108. If this is the case, the section deletion process 118 may end, for example, with the user proceeding to the section editing process 110, so as to manually stitch the gap with another basis, and/or to the point editing process 106 for similar purposes, for example.

At least if the well plan 202 continuity is determined to be automatically recoverable at 1108, the selected section 208 may be removed, as at 1110. The gap may be temporarily displayed in the representation of the domain 200 to indicate to the user that the deletion process is occurring, e.g., substantially in real time. The appropriate extension of the section(s) 208, moving of section(s) 208 of the well plan 202, etc., may be displayed, showing the gap being stitched, as at 1112, thereby generating a modified well plan 202, displayed in the representation of the domain 200 substantially in real-time. In some embodiments, if the well plan 202 continuity is determined to not be recoverable automatically at 1108, the section deletion process 118 may include deleting the selected section at 1110 and forcing the user to manually stitch the gap. Stitching the gap at 1112, whether manually or automatically, may end the iteration of the section deletion process 118, or additional post-processing, analyzing metrics, risk, constraint compliance, etc., may be provided.

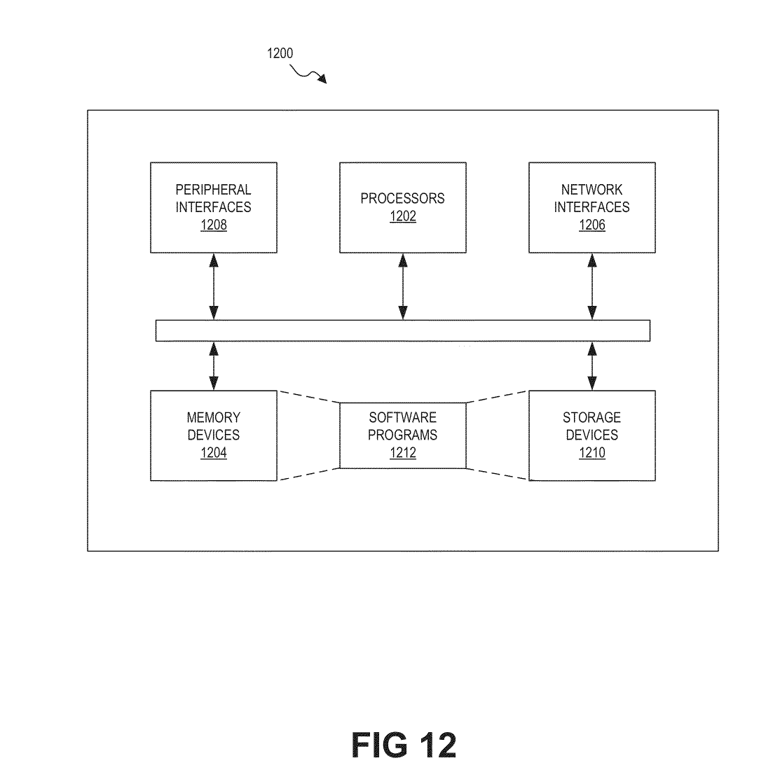

Embodiments of the disclosure may also include one or more systems for implementing one or more embodiments of the method 100. FIG. 12 illustrates a schematic view of such a computing or processor system 1200, according to an embodiment. The processor system 1200 may include one or more processors 1202 of varying core (including multiple cores) configurations and clock frequencies. The one or more processors 1202 may be operable to execute instructions, apply logic, etc. It will be appreciated that these functions may be provided by multiple processors or multiple cores on a single chip operating in parallel and/or communicably linked together.

The processor system 1200 may also include a memory system, which may be or include one or more memory devices and/or computer-readable media 1204 of varying physical dimensions, accessibility, storage capacities, etc. such as flash drives, hard drives, disks, random access memory, etc., for storing data, such as images, files, and program instructions for execution by the processor 1202. In an embodiment, the computer-readable media 1204 may store instructions that, when executed by the processor 1202, are configured to cause the processor system 1200 to perform operations. For example, execution of such instructions may cause the processor system 1200 to implement one or more portions and/or embodiments of the method 100 and/or any of the processes described above.

The processor system 1200 may also include one or more network interfaces 1206. The network interfaces 1206 may include any hardware, applications, and/or other software. Accordingly, the network interfaces 1206 may include Ethernet adapters, wireless transceivers, PCI interfaces, and/or serial network components, for communicating over wired or wireless media using protocols, such as Ethernet, wireless Ethernet, etc.

The processor system 1200 may further include one or more peripheral interfaces 1208, for communication with a display screen, projector, keyboards, mice, touchpads, sensors, other types of input and/or output peripherals, and/or the like. In some implementations, the components of processor system 1200 need not be enclosed within a single enclosure or even located in close proximity to one another, but in other implementations, the components and/or others may be provided in a single enclosure.

The memory device 1204 may be physically or logically arranged or configured to store data on one or more storage devices 1210. The storage device 1210 may include one or more file systems or databases in any suitable format. The storage device 1210 may also include one or more software programs 1212, which may contain interpretable or executable instructions for performing one or more of the disclosed processes. When requested by the processor 1202, one or more of the software programs 1212, or a portion thereof, may be loaded from the storage devices 1210 to the memory devices 1204 for execution by the processor 1202.

Those skilled in the art will appreciate that the above-described componentry is merely one example of a hardware configuration, as the processor system 1200 may include any type of hardware components, including any necessary accompanying firmware or software, for performing the disclosed implementations. The processor system 1200 may also be implemented in part or in whole by electronic circuit components or processors, such as application-specific integrated circuits (ASICs) or field-programmable gate arrays (FPGAs).

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 1200 may be used to execute programs according to instructions received from another program or from another processor system altogether. Similarly, commands may be received, executed, and their output returned entirely within the processing and/or memory of the processor system 1200. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A method for planning a well, comprising:
displaying a three-dimensional representation of a subterranean domain;
receiving a selection of a location in the three-dimensional representation of the subterranean domain;
identifying an object of a well plan associated with the location;
receiving an instruction to modify the object;
editing data associated with the object based on the instruction;
visibly modifying the object in the three-dimensional representation of the subterranean domain, substantially in real-time with respect to receiving the instruction;
determining, using a processor, that the editing of the data results in at least a portion of the well plan being outside of a constraint; and
changing, using the processor, a display of the object to indicate that the editing results in the at least a portion of the well plan being outside of the constraint.

2. The method of claim 1, wherein the object is a point of the well plan, the method further comprising:
displaying one or more selectable indicators associated with a plurality of attributes of the well plan at the point; and
receiving a selection of at least one of the one or more of the selectable indicators, wherein receiving the instruction to modify the object comprises receiving an instruction to modify one or more of the plurality of attributes by manipulation of the at least one of the one or more of the selectable indicators,
wherein changing the display of the object to indicate that the editing results in the at least a portion of the well plan being outside of the constraint comprises editing the display of the at least one of the one or more selectable indicators.

3. The method of claim 2, further comprising:
displaying a second three-dimensional representation of an enlarged portion of the subterranean domain, the second three-dimensional representation of the enlarged portion of the subterranean domain including a view of the point and the at least one of the one or more selectable indicators,
wherein the second three-dimensional representation of the enlarged portion of the subterranean domain is displayed in addition to the three-dimensional representation of the subterranean domain.

4. The method of claim 2, further comprising displaying a range for at least one of the plurality of attributes.

5. The method of claim 1, wherein:
the object is a section of the well plan extending between two points of the well plan;
receiving the instruction comprises:
displaying a plurality of bases each comprising at least one shape; and
receiving a selection of one of the plurality of bases; and
editing the data comprises modifying the section of the well plan to conform to the at least one shape of the one of the plurality of bases that is selected.

6. The method of claim 5, wherein:
determining that the editing of the object results in the at least a portion of the well plan being outside of the constraint comprises:
determining that modifying the section to conform to the at least one shape of the one of the plurality of bases results in at least a portion of the well plan being outside of the constraint; and
changing the display of the object to indicate that the editing results in the at least a portion of the well plan being outside of the constraint comprises visibly indicating that the section is outside of the constraint after modifying the section.

7. The method of claim 1, wherein the object is a section of the well plan extending between two points of the well plan, the instruction to edit the object comprises an instruction to delete the section, and editing the data associated with the object comprises:
deleting the section such that a gap is generated in the well plan between the two points; and
stitching the gap.

8. The method of claim 7, wherein:
determining that the editing of the object results in the at least a portion of the well plan being outside of the constraint comprises determining that stitching the gap results in at least a portion of the well plan being outside of the constraint; and
changing the display of the object to indicate that the editing of the object results in the at least a portion of the well plan being outside of the constraint comprises indicating that continuity of the well plan is not automatically recoverable.

9. The method of claim 1, wherein the object selected is a point of the well plan, the instruction to edit comprises an instruction to append or begin the well plan at the point, and editing the data associated with the object comprises:
receiving a selection of a basis from a plurality of bases;
determining that the basis that is selected would not result in at least a portion of the well plan being outside of the constraint; and
inserting the basis that is selected into the representation of the three-dimensional representation of the subterranean domain such that the basis extends from the point.

10. A computing system, comprising:
a display;
one or more processors coupled with the display; and
a memory system including one or more computer-readable media storing instructions that, when executed by at least one of the one or more processors, cause the computing system to perform operations, comprising:
displaying, on the display, a three-dimensional representation of a subterranean domain including a well plan, wherein the well plan comprises a plurality of sections;
receiving a selection of one of the plurality of sections;
receiving an instruction to edit the one of the plurality of sections; and
visibly altering the one of the plurality of sections based on the instruction, so as to alter the three-dimensional rendering of the well plan substantially in real-time with respect to receiving the instruction.

11. The system of claim 10, wherein receiving the selection of the one of the plurality of sections comprises receiving a selection of a point contained in the one of the plurality of sections, the operations further comprising displaying one or more indicators associated with one or more attributes of the section at the point, wherein receiving the instruction to edit the at least one of the plurality of sections comprises receiving a manipulation at least one of the one or more indicators.

12. The system of claim 11, wherein at least one of the one or more attributes is selected from a group consisting of well plan inclination, well plan azimuth, and a position of the point in the subterranean domain.

13. The system of claim 11, further comprising visibly adjusting the at least one of the one or more indicators when the instruction results in the well plan being outside of a constraint.

14. The system of claim 11, wherein the operations further comprise receiving a selection of the at least one of the one or more indicators and adjusting a view of the three-dimensional representation of the subterranean domain based on the one of the indicators that is selected.

15. The system of claim 11, wherein the operations further comprise receiving a selection of the at least one of the one or more indicators and displaying a second view of the subterranean domain, the second view being an enlargement of a portion of the representation of the subterranean domain and including an area proximal to the point that is selected.

16. The system of claim 15, further comprising modifying the second view substantially simultaneously to receiving the instruction.

17. The system of claim 10, wherein:
receiving the instruction comprises receiving a sequence of instructions during a period of time; and
visibly altering the at least one of the plurality of sections comprises:
modifying the at least one of the plurality of sections according to a first one of the sequence of instructions during the period of time; and
visibly displaying the modified at least one of the plurality of sections during the period of time.

18. The system of claim 10, further comprising selecting a new basis for the at least one of the plurality of sections when the instruction results in the well plan being outside of a constraint.

19. A non-transitory computer-readable medium storing instructions that, when executed by a computing system, cause the computing system to perform operations, the operations comprising:
displaying a three-dimensional representation of a subterranean domain including a well plan, wherein the well plan comprises a plurality of points;
receiving a selection of one of the plurality of points;
displaying a plurality of attribute indicators associated with the selected one of the plurality of points;
receiving a selection of at least one of the plurality of attribute indicators;
receiving an instruction to modify a position, trajectory, or both of the well plan using the at least one of the plurality of attribute indicators that is selected, wherein the instruction is received over a period of time; and
visibly altering the at least one of the plurality of attributes based on the instruction, so as to alter the three-dimensional rendering of the well plan during the period of time.

20. The computer-readable medium of claim 19, further comprising:
displaying a second view of the domain, the second view being an enlargement of the representation of the subterranean domain and including an area proximal to the point that is selected;
displaying, in the second view, at least one visual indicator for the at least one of the plurality of attributes that is selected;
modifying the second view based on the at least one of the plurality of attributes that is selected;
determining whether the instruction results in at least a portion of the well plan being outside of a constraint; and
visibly adjusting the indicator when the instruction results in the well plan being outside of the constraint.
